(19) United States
(12) Patent Application Publication
(10) Pub. No.: US 2022/0058924 A1
(43) Pub. Date: Feb. 24, 2022

(54) SECURITY SYSTEM

(71) Applicant: SAFE CASE TECHNOLOGIES PTY LTD, Murarrie (AU)

(72) Inventor: Stephen Robert PAREEZER, Murarrie (AU)

(21) Appl. No.: 17/520,184

(22) Filed: Nov. 5, 2021

Related U.S. Application Data
(63) Continuation-in-part of application No. PCT/AU2020/050453, filed on May 8, 2020.

(30) Foreign Application Priority Data
May 9, 2019 (AU) 2019901586
Jun. 30, 2021 (AU) 2021103759

(51) Int. Cl. G08B 13/14; G08B 13/196; G07C 9/00; H04W 4/029; H04W 4/80; H04W 4/021

(52) U.S. Cl. CPC G08B 13/1427; G08B 13/196; G07C 9/00309; G07C 9/00896; G07C 2009/0092; H04W 4/80; H04W 4/021; G07C 2009/00769; H04W 4/029

(57) ABSTRACT

Provided is a security system for secure delivery of valuable goods. The security system includes an asset, and a portable container for transporting the valuable goods to or from the asset. An alarm system is provided for generating an alarm upon the portable container being stolen. Advantageously, the alarm system may reduce the likelihood of successful CIT armed robbery in which the portable container is stolen, thereby deterring the CIT armed robbery altogether.

### RELATED APPLICATIONS

This application is a continuation-in-part of International Patent Application No. PCT/AU2020/050453, filed May 8, 2020, which claims the benefit of Australian Provisional Patent Application No. 2019901586, filed May 9, 2019, and claims the benefit of Australian Innovation Application No. 2021103759, filed Jun. 30, 2021, the contents of which are herein incorporated by reference in their entirety.

### TECHNICAL FIELD

The present invention generally relates to a security system for secure delivery of valuable goods.

The present invention has particular, although not exclusive application to portable cashboxes transporting cash to or from armored vehicles.

### BACKGROUND

The reference to any prior art in this specification is not, and should not be taken as an acknowledgement or any form of suggestion that the prior art forms part of the common general knowledge.

Portable cashboxes are carried by armed guards when transporting cash between armored vehicles and companies.

Cash in transit (CIT) armed robbery can cause serious stress and danger to individuals who become victims while doing their job. To compound the emotional, psychological and physical damage CIT armed robbery can cause victims, it also often causes considerable financial loss to the companies targeted. CIT armed robberies have been increasing in recent years.

The preferred embodiment provides a security system to deter CIT armed robbery.

### SUMMARY OF THE INVENTION

According to one aspect of the present invention, there is provided a security system for secure delivery of valuable goods, the security system including:
an asset being an armoured vehicle or a financial institution;
a portable container for carrying by a guard and transporting the valuable goods to or from the asset, the portable container being configured to be in communication with a communications device borne by the guard; and
an alarm system for generating an alarm upon the portable container being stolen from the guard, wherein the alarm system is Bluetooth enabled and the alarm is generated in response to detecting that a Bluetooth connection between the communications device borne by the guard and the portable container is broken and in response to the portable container not being proximal to the asset for a pre-determined period of time; and
a monitoring station configured to be in communication with the portable container to receive alarm data and GPS tracking data from the portable container, wherein the portable container is configured to send the alarm data and the GPS tracking data via an Internet-of-Things (IoT) network in response to the alarm being generated.

Advantageously, the alarm system may reduce the likelihood of successful CIT armed robbery in which the portable container is stolen, thereby deterring the CIT armed robbery altogether.

The alarm may be a proximity alarm. The alarm system may be Bluetooth enabled.

The security system may include a smartphone (or other communications device) borne by a transporter (e.g. armed guard) of the container. The proximity alarm may be generated when the container is not proximal a smartphone borne by the transporter.

The proximity alarm may be actuated when the container is not proximal the asset. The proximity alarm may be generated responsive to the container not being proximal to the asset for a pre-determined period of time.

The security system may further include a security camera for capturing images. The security camera may be borne by the container.

The container may include a tracking device to facilitate tracking of the container. The tracking device may include a GPS.

The container may be internet enabled. The security system may further include a monitoring station for receiving information from the portable container, asset and/or smartphone.

The portable container may weight less than 20 kg. The portable container may include a box weighing less than 7.5 kg. The box may include ballistic shielding material.

The container may comprise an electronic lock configured to open the container in response to receiving a command, via the Internet, from the monitoring station.

The asset may include an armored vehicle. Alternatively, the may include a building (e.g. bank). The portable container may include a cashbox. The valuable goods may include cash.

According to another aspect of the present invention, there is provided portable container carried by a guard and for a security system used in the secure delivery of valuable goods, the security system including an asset being an armoured vehicle or a financial institution to or from which the portable container is used to transport the valuable goods; the container being configured to be in communication with a communications device borne by the guard, the container including: an alarm system for generating an alarm upon the portable container being stolen from the guard, wherein the alarm system is Bluetooth enabled and the alarm is raised in response to detecting that a Bluetooth connection between the communications device borne by the guard and the portable container is broken and in response to the portable container not being proximal to the asset for a pre-determined period of time, wherein the container is configured to send alarm data and GPS tracking data to a monitoring station via an Internet-of-Things (IoT) network in response to the alarm being generated.

According to another aspect of the present invention, there is provided a security method for secure delivery of valuable goods, the security method including: transporting the valuable goods to or from an asset being an armoured vehicle or a financial institution in a portable container carried by a guard, the portable container being configured to be in communication with a communications device borne by the guard; generating an alarm upon the portable container being stolen from the guard, wherein the alarm is generated in response to detecting that a Bluetooth connection between the communications device borne by the guard and the portable container is broken and in response to the portable container not being proximal to the asset for a pre-determined period of time; in response to generating the alarm, transmitting, by the portable container, alarm data and GPS tracking data to a monitoring station via an Internet-of-Things (IoT) network.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a drawing as follows:

FIG. 1 is a schematic diagram of a security system in accordance with an embodiment of the present invention.

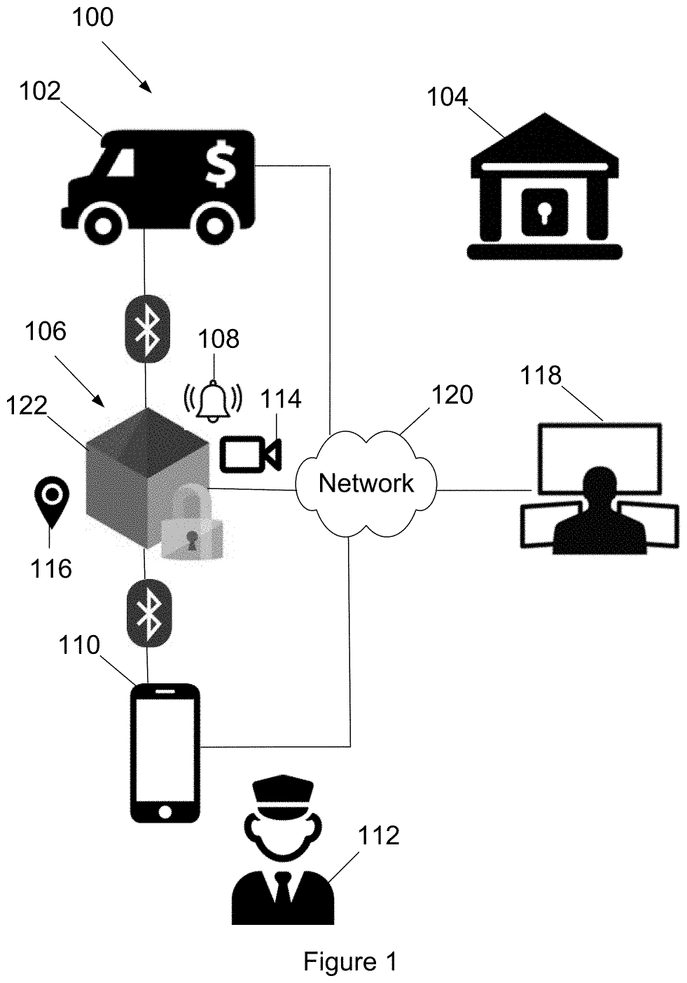

### DETAILED DESCRIPTION OF PREFERRED EMBODIMENTS

According to an embodiment of the present invention, there is provided a security system 100 for secure delivery of cash (i.e. valuable goods) between an armored vehicle 102 and a bank building 104 (i.e. assets).

The security system 100 includes a portable container 106 for manually transporting the cash to or from the armored vehicle 102. An alarm system 108 is provided for generating an alarm upon the portable container 106 being stolen.

Advantageously, the alarm system 108 reduces the likelihood of successful CIT armed robbery in which the portable container 106 is stolen, thereby deterring the CIT armed robbery altogether.

The alarm 108 is a proximity alarm which is Bluetooth enabled. The security system 100 further includes a smartphone 110 (or other communications device) borne by an armed guard 112 (i.e. transporter) transporting the container 106. The proximity alarm is instantly generated when the container 106 is not proximal the guard's smartphone 110, when the container 106 is stolen away and the Bluetooth connection is broken.

The proximity alarm 108 is also actuated when the container 106 is not proximal the armored vehicle 102 for a predetermined period of time. The predetermined period of time would allow for the guard 112 to reasonably make the cash pickup or delivery out of Bluetooth range, but would not be longer.

The security system 100 further includes a security camera 114 for capturing video images. The security camera 114 is borne by the container 106 and captures images of the container surrounds.

The container 106 also includes a GPS tracker 116 to facilitate tracking of the container 106. The container 106 communicates with a monitoring station 118 via a network 120 including the internet (i.e. IoT). The monitoring station 118 receives information from the portable container 106, armored vehicle 102 and/or guard's smartphone 112. The information includes the alarm from the alarm system 108, GPS tracking information from the GPS tracker 116 and uploaded video from the camera 114.

The container 106 is also configured to be remotely opened. For example, the container 106 may comprise an electronic lock configured to open the container in response to receiving a command, via the Internet, from the monitoring station 118. In some implementations, the electronic lock may comprise an Internet-of-Things sensor receiving the command from the monitoring station 118, a controller and at least one hardware locking component. The Internet-of-Things sensor may be coupled with the controller controlling the at least one hardware locking component.

In one implementation, the Internet-of-Things sensor may be configured to receive a command from the monitoring station 118 via an Internet-of-Things network and send the command to the controller. The controller of the electronic lock is configured to receive the command from the Internet-of-Things sensor. Once the command is received, the controller processes the command. Processing the command triggers instructions to the hardware locking components, such as a hardware lock, of the electronic lock. The instructions are typically stored in a memory of the controller. The controller controls a state of the hardware lock by executing the stored instructions. For example, by executing the stored instructions, the controller may release the lock and open the container 106 in response to receiving a remote command from the monitoring station 118 to open the container 106. Once the container 106 has been unlocked, the container 106 may be locked again automatically once the container is closed.

The portable container 106 weighs less than 20 kg for ease of manual handling. The portable container 106 includes a lockable cashbox 122, formed from ballistic shielding material, weighing less than 7.5 kg.

A security method for secure delivery of the cash is provided. The security method involves transporting the cash to or from the armored vehicle 102 in the portable container 106. Further, the security method involves generating the alarm upon the portable container 106 being stolen.

The security method may also involve remotely opening the container 106 in response to receiving a command, via the Internet, from the monitoring station 118. For example, the security method may involve controlling the hardware lock of the electronic lock using the controller to open the lock in response to receiving a command from the monitoring station to open the container 106. The method may also involve automatically locking the container 106 in response to closing a lid of the container 106. For example, when the lockable cashbox is closed, the hardware lock may automatically lock the cashbox.

A person skilled in the art will appreciate that many embodiments and variations can be made without departing from the ambit of the present invention.

The preferred embodiment was described in relation to secure delivery of cash to a bank, but there are many other applications. For example, the present invention is suitable for secure delivery of other types of valuable goods such as jewelry, bullion, financial instruments or legal documents to companies and other institutions.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

What is claimed is:

1. A security system for secure delivery of valuable goods, the security system including:
an asset being an armoured vehicle or a financial institution;
a portable container for carrying by a guard and transporting the valuable goods to or from the asset, the portable container being configured to be in communication with a communications device borne by the guard;
an alarm system for generating an alarm upon the portable container being stolen from the guard, wherein the alarm system is Bluetooth enabled and the alarm is generated in response to detecting that a Bluetooth connection between the communications device borne by the guard and the portable container is broken and in response to the portable container not being proximal to the asset for a pre-determined period of time; and
a monitoring station configured to be in communication with the portable container to receive alarm data and GPS tracking data from the portable container, wherein the portable container is configured to send the alarm data and the GPS tracking data via an Internet-of-Things (IoT) network in response to the alarm being generated.

2. A security system as claimed in claim 1, wherein the alarm system reduces the likelihood of successful cash in transit (CIT) armed robbery in which the portable container is stolen, thereby deterring the CIT armed robbery.

3. A security system as claimed in claim 1, wherein the alarm is a proximity alarm.

4. A security system as claimed in claim 1, wherein the communications device is a smartphone borne by the guard transporting the container.

5. A security system as claimed in claim 1, further including a security camera for capturing images.

6. A security system as claimed in claim 5, wherein the security camera is borne by the portable container.

7. A security system as claimed in claim 1, wherein the container includes a tracking device to facilitate tracking of the container.

8. A security system as claimed in claim 7, wherein the tracking device includes a GPS.

9. A security system as claimed in claim 1, wherein the container is internet enabled.

10. A security system as claimed in claim 1, wherein the monitoring station is configured to receive the alarm from the portable container, asset and/or a smartphone, GPS tracking data from the portable container and at least one image captured by a security camera borne by the portable container.

11. A security system as claimed in claim 1, wherein the portable container weighs less than 20 kg.

12. A security system as claimed in claim 1, wherein the portable container includes a box weighing less than 7.5 kg, the box preferably being a cashbox.

13. A security system as claimed in claim 12, wherein the box includes ballistic shielding material.

14. A security system as claimed in claim 1, wherein the portable container includes an electronic lock configured to open the portable container in response to receiving a command, via the Internet, from the monitoring station.

15. A portable container carried by a guard and for a security system used in the secure delivery of valuable goods, the security system including an asset being an armoured vehicle or a financial institution to or from which the portable container is used to transport the valuable goods; the container being configured to be in communication with a communications device borne by the guard, the container including:
an alarm system for generating an alarm upon the portable container being stolen from the guard, wherein the alarm system is Bluetooth enabled and the alarm is raised in response to detecting that a Bluetooth connection between the communications device borne by the guard and the portable container is broken and in response to the portable container not being proximal to the asset for a pre-determined period of time,
wherein the container is configured to send alarm data and GPS tracking data to a monitoring station via an Internet-of-Things (IoT) network in response to the alarm being generated.

16. A portable container as claimed in claim 15, further including an electronic lock configured to open the portable container in response to receiving a command, via the Internet, from the monitoring station.

17. A security method for secure delivery of valuable goods, the security method including:
transporting the valuable goods to or from an asset being an armoured vehicle or a financial institution in a portable container carried by a guard, the portable container being configured to be in communication with a communications device borne by the guard;
generating an alarm upon the portable container being stolen from the guard, wherein the alarm is generated in response to detecting that a Bluetooth connection between the communications device borne by the guard and the portable container is broken and in response to the portable container not being proximal to the asset for a pre-determined period of time;
in response to generating the alarm, transmitting, by the portable container, alarm data and GPS tracking data to a monitoring station via an Internet-of-Things (IoT) network.

18. A security method as claimed in claim 17, further comprising opening an electronic lock of the portable container in response to receiving a command, via the Internet, from the monitoring station.
